(19) United States
(12) Patent Application Publication
(10) Pub. No.: US 2007/0253419 A1
(43) Pub. Date: Nov. 1, 2007

(54) Communication terminal apparatus and image printing apparatus

(75) Inventor: Osamu Oshima, Fushimi-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/790,323

(22) Filed: Apr. 25, 2007

(30) Foreign Application Priority Data
Apr. 27, 2006 (JP) 2006-122923

(51) Int. Cl. H04L 12/56

(52) U.S. Cl. 370/392

(57) ABSTRACT

A communication terminal apparatus that transmits image data to a destination according to destination information when an RF reader retrieves the destination information from an RFID tag attached to an original document having acquired image, data.

### BACKGROUND OF THE INVENTION

1. Field of the Invention

The present invention relates to a communication terminal apparatus and an image printing apparatus. Specifically, the communication terminal apparatus can retrieve information from a storage medium attached to an original document via a wireless communication. Also specifically, the image printing apparatus can write information to a storage medium attached to a recording sheet on which an image is recorded via the wireless communication.

2. Description of the Related Art

By attaching a storage medium in which various information is electronically written to a recording sheet on which an image is recorded, adequate utilization or control of the recording sheet can be performed reliably on the basis of the information retrieved from the storage medium. Recently, utilization of an IC chip of an RFID (Radio Frequency-Identification) tag that the information is written to or retrieved from via a wireless communication as such storage medium is proposed.

For example, an MFP (multiple Functional Peripheral) as a communication apparatus, which is configured to write identification information of a transmitting job (transmitting job ID) to the RFID tag of an original document for reading and transmitting the image therefrom so that the transmitting result is easily and reliably confirmed is known. The identification information of the transmitting job includes a reception number of the transmitting job, a facsimile number of a destination, a source facsimile number, and date and time of reception or date and time of transmitting.

However, according to such MFP, since the destination of the original document is input by a user through an operating unit, if the user inputs a wrong destination, a document image as a secret document may disadvantageously be transmit to a wrong destination. In addition, since the user needs to input the destination, the transmitting operation is disadvantageously complicated.

In view of such circumstances, in a communication terminal apparatus which can retrieve information from a storage medium attached to an original document via a wireless communication, it is an object of the invention to provide a communication terminal apparatus in which the original documents are reliably prevented from being transmit erroneously to a wrong destination, and the transmitting operation is simplified. It is another object of the invention to provide an image printing apparatus in which the original documents suitable for such communication terminal apparatus are prepared.

### SUMMARY OF THE INVENTION

In order to achieve the above-described objects, a communication terminal apparatus according to the present application includes an image data acquiring device, a retrieving device, and a transmitting device. The image data acquiring device reads images on original documents and acquires image data. The retrieving device retrieves information from storage medium each attached to the original documents via a wireless communication. The transmitting device transmits the image data acquired by the image data acquiring device to a destination indicated by destination information when the retrieving device retrieves the destination information.

The communication terminal apparatus according to the present application may further includes an operation inputting device configured to operate to input destinations. In this case, the transmitting device can transmit the data only to the destination that the destination information indicates from between the destinations that the destination information retrieved by the retrieving device indicates, and the destination input through the operation inputting device.

The communication terminal apparatus according to the present application may further include an operation inputting device configured to operate to input destinations. In this case, the transmitting device can transmit the data to the destination that the destination information retrieved by the retrieving device indicates, and the destination input through the operation inputting device.

The communication terminal apparatus according to the present application may be configured in such a manner that the transmitting device inhibits the transmitting process when the retrieving device retrieves transmit inhibit information.

In the communication terminal apparatus according to the present application, the destination information may be a facsimile number or an electronic mail address.

An image printing apparatus according to the present application includes a printing device, a accepting device, and a writing device. The printing device prints an image onto a recording sheet. The accepting device accepts destination information indicating a destination as writing information. The writing device writes the writing information accepted by the accepting device into a storage medium attached to the recording sheet via a wireless communication.

The image printing apparatus according to the present application may further include an operation inputting device configured to operate to input writing information. In this case, the accepting device can accept the writing information input through the operation inputting device.

In the image printing apparatus according to the present application, the destination information may be a facsimile number or an electronic mail address.

When the retrieving device retrieves the destination information from the storage medium attached to the original document, the communication terminal apparatus according to the present application transmits the image data acquired by the image data acquiring device to the destination that the destination information indicates. Therefore the image data acquired by reading the image on the original document can be transmit automatically to the destination that the destination information, which is written in advance in the storage medium attached to the original document, indicates. Therefore, the image data can be transmit reliably to the destination that the destination information indicates, and the image data is prevented from leaking due to erroneous transmitting, so that enhancement of the security is achieved. Since the destination information is retrieved from the storage medium attached to the original document, that is, since the destination information electronically stored in the storage medium is retrieved, an accurate destination information can reliably be retrieved. For example, when acquiring the destination information through character recognition of characters visually written in the original document with image forming material such as toner, it is very difficult to achieve 100% accuracy of character recognition without error, and there is a possibility that the accuracy of character recognition is lowered by the density of the characters. However, according to the communication terminal apparatus in the invention, since the destination information is retrieved from the storage medium attached to the original document, the destination information without error can reliably acquired. Since the transmitting process is achieved without inputting the destination by the user, the transmitting process can be simplified.

When the retrieving device retrieves the destination information from the storage medium attached to the original document, the communication terminal apparatus according to the present application transmits the image data only to the destination that the destination information indicates even when the destination is input through the operation inputting device. Therefore, the destination of the original document is reliably limited, and the image data can be transmitted only to the destination that the destination information indicates, so that the image data is prevented from being transmit to a wrong destination. Therefore, a reliable control of the transmitting of the original document is achieved.

The communication terminal apparatus according to the present application transmits the image data to the destination indicated by the destination information that the retrieving device retrieved from the storage medium attached to the original document, and to the destination input through the operation inputting device. Therefore, the destination of the original document is not limited to the specified destination written in the storage medium, and the image data can also be transmitted to the destination input through the operation inputting device. Therefore, a flexible control of the transmitting of the original document is achieved.

The communication terminal apparatus according to the present application inhibits the transmitting process when the retrieving device retrieves the transmit inhibit information from the storage medium attached to the original document. Therefore, the original document is reliably prevented from being transmitted, and hence an inadequate transmitting is reliably prevented. Therefore, a reliable control of the transmitting of the original document is achieved.

In the communication terminal apparatus according to the present application, the destination information is the facsimile number or the electronic mail address. Therefore, the image data can be transmitted, for example, to the facsimile apparatus or the internet facsimile apparatus having the facsimile number or the electronic mail address as a destination, and a reliable control of the transmitting is achieved.

In the image printing apparatus according to the present application, the writing device writes the destination information indicating the destination that the accepting device accepts as the writing information into the storage medium attached to the recording sheet for printing the image via the wireless communication. Therefore, the recording sheet on which the image is printed is attached with the storage medium in which the destination information is written. Therefore, by using this recording sheet in the communication terminal apparatus as the original document, the recording sheet is reliably transmitted to the destination that the destination information indicates, and the image data is prevented from leaking due to the erroneous transmitting, so that enhancement of the security is achieved. Since the user can transmit the recording sheet without input the destination, the transmitting process can be simplified.

In the image printing apparatus according to the present application, the accepting device accepts the writing information written in the storage medium attached to the recording sheet for printing the image by inputting through the operation inputting device. Therefore, the writing information such as information on the usage including the transmitting of the recording sheet can be inputted through the operating device as desired so that an adequate usage of the recording sheet is reliably achieved.

In the image printing apparatus according to the present application, the destination information is the facsimile number or the electronic mail address. Therefore, the image data acquired from the image printed on the recording sheet can be transmitted, for example, to the facsimile apparatus or the internet facsimile apparatus having the facsimile number or the electronic mail address as a destination, and a reliable control of the transmitting is achieved.

Other features, elements, processes, steps, characteristics and advantages of the present invention will become more apparent from the following detailed description of preferred embodiments of the present invention will reference to the attached drawings.

### BRIEF DESCRIPTION OF THE DRAWINGS

FIG. 1 illustrates a block diagram of a configuration of an MFP according to a preferred embodiment of the present invention.

FIG. 2 illustrate a schematic cross-sectional view for explaining the interior of the MFP.

FIG. 3 is a flowchart illustrating a processing operation executed in the MFP when printing an image.

FIG. 4 is a flowchart illustrating a processing operation executed in the MFP when printing the image.

FIG. 5 is a flowchart illustrating a processing operation executed in the MFP when transmitting image data acquired by reading an image on an original document.

FIG. 6 is a flowchart illustrating a processing operation executed in the MFP when transmitting the image data acquired by reading the image on the original document.

### DETAILED DESCRIPTION OF THE PREFERRED EMBODIMENTS

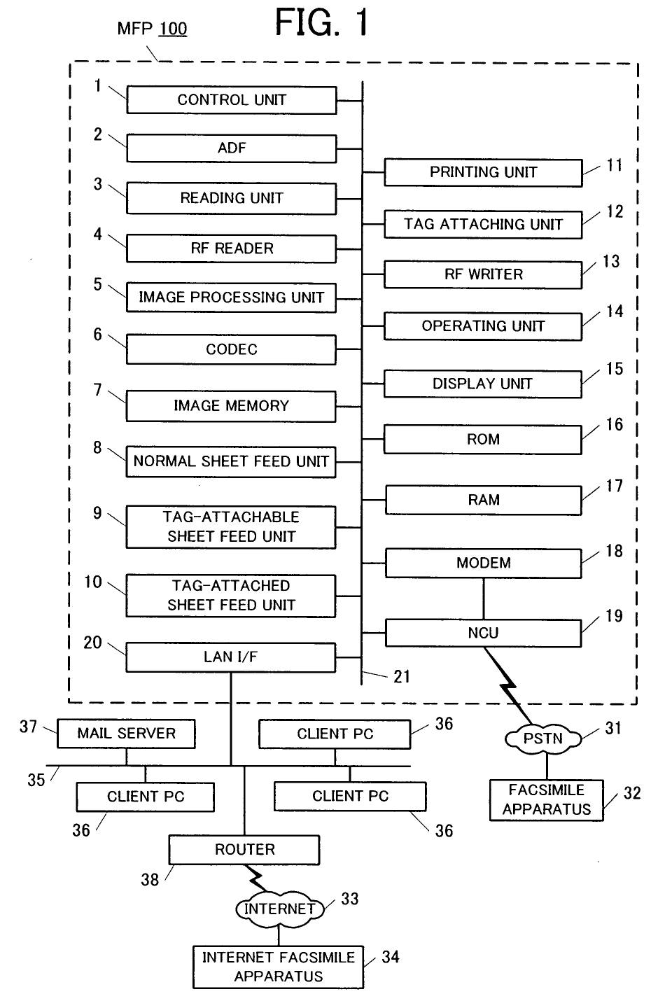

Referring now to the drawings, an MFP (Multiple Functional Peripheral) 100 provided with a communication terminal apparatus and an image printing apparatus according to the preferred embodiments of the present invention will be described. As shown in a block diagram in FIG. 1, the MFP 100 includes a control unit (CPU: Central Processing Unit) 1, an ADF (Automatic Document Feeder) 2, a reading unit 3, an RF (Radio Frequency) reader 4, an image processing unit 5, a CODEC (Coder and Decoder) 6, an image memory 7, a normal sheet feed unit 8, a tag-attachable sheet feed unit 9, a tag-attached sheet feed unit 10, a printing unit 11, a tag attaching unit 12, an RF writer 13, an operating unit 14, a display unit 15, a ROM (Read Only Memory) 16, a RAM (Random Access Memory) 17, a modem 18, an NCU (Network Control Unit) 19, and a LAN I/F (Local Area Network Interface) 20. The respective components 1 to 20 are communicably connected by busses 21.

The MFP 100 configured as described above has a function as the communication terminal apparatus for transmitting image data to a separate apparatus. More specifically, a facsimile transmitting function for transmitting acquired image data of an original document to a facsimile apparatus 32 communicably connected thereto via a PSTN (Public Switched Telephone Network) 31 and an electronic mail transmitting function for transmitting an electronic mail, on which acquired image data of the original document is attached as an image file, to an internet facsimile apparatus 34 communicably connected thereto via an internet 33 are provided. The MFP 100 has a facsimile receiving function for receiving image data from the facsimile apparatus 32 and an electronic mail receiving function for receiving an electronic mail on which image data is attached as the image file from the internet facsimile apparatus 34.

The MFP 100 further has a function as the image printing apparatus for printing images on recording sheets. More specifically, a copying function for printing an image of an original document read by the reading unit 3 on the recording sheet and a printing function for printing an image on the basis of image data received from the facsimile apparatus 32 or the internet facsimile apparatus 34 and image data transferred from a client PC 36 communicably connected via a LAN (Local Area Network) 35 on the recording sheet.

The control unit 1 controls operations of the respective components of the MFP 100.

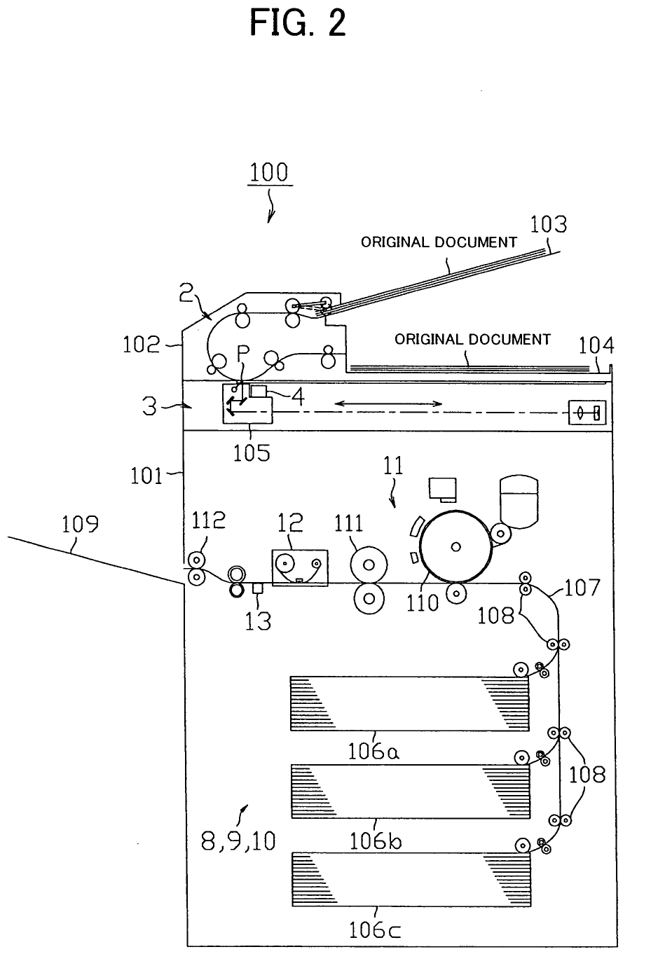

As shown in FIG. 2 showing the interior of the MFP 100, the ADF 2 is provided in a document holding cover 102 pivotably supported by a document placing bed 101 which functions as an FBS (Flat Bed Scanner) so as to be openable and closable, and carries the original documents placed on a document tray 103 one by one along a carrier path and then discharges the same to a document discharge tray 104. The ADF 2 includes a paper feed roller for feeding the original document in the document tray 103 to the carrier path, a carrier roller for carrying the original document fed to the carrier path, and paper discharge rollers for discharging the original document carried along the carrier path to the document discharge tray 104. Although not shown in the drawings, there is provided a detection sensor for detecting whether or not the original document is placed on the document discharge tray 104.

The reading unit 3 is configured to read the image on the original document to acquire the image data, and is integrated in the document placing bed 101 as a CCD reading unit of a reduction optical system including a light source for illuminating the original document, a plurality of reflection mirrors for guiding reflected light beams from the original document to a predetermined directions, a converging lens for conversing reflected light beams from the original document, and a CCD (Charge Coupled Device) line sensor that converts the converged light beam into electrical signals and outputs the same. The light source and some of the reflection mirrors are disposed on a scanning carriage 105 which reciprocates horizontally with a drive mechanism, not shown, with respect to a platen glass 101a disposed on the top surface of the document placing bed 101. Although not shown, a detection sensor for detecting whether or not the original document is placed on the platen glass 101a.

When the reading unit 3 reads an image of the original document as the FBS, the scanning carriage 105 scans the original document placed on the platen glass 101a by moving from a waiting position (the position shown in FIG. 2) located below the platen glass 101a horizontally with respect to the platen glass 101a, and guides reflected light beams from the original document to the CCD line sensor to form an image. In contrast, when the reading unit 3 reads an image of the original document carried by the ADF2, the scanning carriage 105 guides reflected light beams from the original document passing through a reading position P to the CCD line sensor at the waiting position to form an image.

The RF reader 4 retrieves information from an RFID (Radio Frequency Identification) tag via the wireless communication, and is disposed in the scanning carriage 105. The RFID tag includes a microminiature IC (integral circuit) chip and a coil antenna for the wireless communication, although not shown, and the IC chip includes a storage area (storage medium), a power rectifier, a sender, and a receiver. When the RFID tag receives an electric wave oscillated by the RF reader 4, an electromotive power is generated in the RFID tag by the resonance action, and the RFID tag emits information written in the storage area in advance by the generated electromotive power. The RF reader 4 retrieves the information from the storage by receiving the information emitted from the RFID tag in this manner. When the RF reader 4 retrieves the information from the storage area of the RFID tag in which the information relating to the original document is written when being attached to the original document, the information relating to the original document can be obtained.

When the reading unit 3 reads the image of the original document as the FBS, RF reader 4 retrieves the information by the scanning carriage 105 moving horizontally with respect to the platen glass 101a from the RFID tag of the original document placed on the platen glass 101a. When the image of the original document carried by the ADF 2 is read by the reading unit 3, the information is retrieved by the scanning carriage 105 being standstill at the waiting position from the RFID tag of the original document passing through the reading position P.

The communication range of the RF reader 4 used in this embodiment is set in advance so as to be capable of retrieving the information irrespective of the widthwise position of the RFID tag with respect to the original document. The communication range of the RF reader 4 used in this embodiment does not reach the document tray 103 and the document discharge tray 104 so that the information is retrieved only from the RFID tag attached to the original document placed on the platen glass 101a or the original document passing through the reading position P. The RF reader 4 does not retrieve the information from the RFID tag of the original document placed on the document tray 103 and the document discharge tray 104.

The image processing unit 5 performs image processing on image data of the original document acquired by the reading unit 3. More specifically, the image processing unit 5 performs the image processing such as shading correction, y correction, enlargement/contraction (interpolation or thinning of pixel data) on the image data that the reading unit 3 read from the original document and outputted as the image as needed.

The CODEC 6 encodes and decodes the image data. In this embodiment, the image data of the original document processed by the image processing unit 5 is coded and the encoded image data is decoded. The reading unit 3, the image processing unit 5, and the CODEC 6 function as image data acquiring devices.

The image memory 7 stores the image data such as the image data encoded by the CODEC 6, the image data directly outputted from the image processing unit 5, and the image data received through the facsimile. Image data received from the facsimile apparatus 32, image data attached to an electronic mail as an image file received from the internet facsimile apparatus 34, and image data transferred from the client PC 36 may also be stored in the image memory 7.

The normal sheet feed unit 8 feeds recording sheets such as normal sheet (hereinafter, referred to as “normal sheet”), which is not suitable for being attached with the RFID tag toward the printing unit 11. Although the tag-attachable sheet feed unit 9 feeds recording sheets which are suitable for being attached with the RFID tag but are not attached with the RFID tag (hereinafter referred to as “tag-attachable sheet”) to the printing unit 11. The tag-attached sheet feed unit 10 feeds recording sheets which are attached with the RFID tag by embedment (infiltration) or adhesion (hereinafter, referred to as “tag-attached sheet”) to the printing unit 11.

The MFP 100 is provided with a plurality of paper feed cassettes 106a to 106c in which recording sheets of predetermined sizes can be stored so as to be drawable therefrom as showing the interiors thereof in FIG. 2, so that the recording sheets can be filled in the paper feed cassettes 106a to 106c as needed. The recording sheets stored in the respective paper feed cassettes 106a to 106c are fed out by a pickup roller, nipped by a pair of paper feed rollers and fed to a carrier path 107 which continues to the printing unit 11. Such paper feed cassettes 106a to 106c accommodate the normal sheets, the tag-attachable sheets and the tag-attached sheets of the predetermined sizes. For example, the normal sheets of A4 size are stored in the paper feed cassette 106a, the tag-attachable sheets of A4 size are stored in the paper feed cassette 106b, and the tag-attached sheets of A4 size are stored in the paper feed cassette 106c. The recording sheets fed from the respective paper feed cassettes 106a to 106c to the carrier path 107 are carried along the carrier path 107 by a plurality of carrier rollers 108 and are fed to the printing unit 11. The carrier path 107 extends from one end sides of the respective paper feed cassettes 106a to 106c to the printing unit 11 and extends further to communicate with a paper discharge tray 109.

In the MFP 100 configured as described above, the normal sheet feed unit 8 includes the paper feed cassette 106a for accommodating the normal sheets, the pickup roller and the paper feed rollers associated with the paper feed cassette 106a, and parts of the carrier path 107 and the carrier rollers 108. The normal sheet feed unit 8 feeds the normal sheets of a predetermined size to the printing unit 11 by feeding the normal sheets from the paper feed cassette 106a. The tag-attachable sheet feed unit 9 includes the paper feed cassette 106b for accommodating the tag-attachable sheets, the pickup roller and the paper feed rollers associated with the paper feed cassette 106b, and parts of the carrier path 107 and the carrier rollers 108. The tag-attachable sheet feed unit 9 feeds the tag-attachable sheets of a predetermined size to the printing unit 11 by feeding the tag-attachable sheets from the paper feed cassette 106b. On the other hand, the tag-attached sheet feed unit 10 includes the paper feed cassette 106c for accommodating the tag-attached sheet, the pickup roller and the paper feed rollers associated with the paper feed cassette 106c, and parts of the carrier path 107 and the carrier rollers 108. The tag-attached sheet feed unit 10 feeds the tag-attached sheets of a predetermined size to the printing unit 11 by feeding the tag-attached sheets from the paper feed cassette 106c. Although not shown, the paper feed cassettes 106a to 106c each include a detection sensor for detecting whether or not the recording sheets are stored.

The printing unit 11 prints an image of the image data retrieved from the image memory 7 on the recording sheet. The printing unit 11 prints images on the normal sheets fed from the normal sheet feed unit 8, the tag-attachable sheets fed from the tag-attachable sheet feed unit 9, and the tag-attached sheets fed from the tag-attached sheet feed unit 10. The printing unit 11 includes a photoconductor drum 110, a charging device disposed around the photoconductor drum 110, an LED head, a developing unit, a transfer roller and a cleaning unit, and a fixer 111 disposed on the carrier path 107 on the downstream side of the photoconductor drum 110 as shown in FIG. 2.

The photoconductor drum 110 is driven to rotate, and a surface thereof is charged by the charging device at a constant voltage, and is exposed selectively by the LED head on the basis of the image data, so that an electrostatic latent image is formed thereon. The electrostatic latent image on the surface of the photoconductor drum 110 is developed by the developing unit, so that a toner image is formed. The toner image formed on the surface of the photoconductor drum 110 is transferred to the recording sheet by the transfer roller. The toner or the like remaining on the surface of the photoconductor drum 110 is removed by the cleaning unit. The fixer 111 fixes the toner image transferred to the recording sheet carried through the carrier path 107 by heating and pressurizing the same. A printing system employed in the printing unit 11 is not limited to a electrophotographic type, and various printing systems such as the ink jet printing system may be used. The recording sheets on which the images are printed by the printing unit 11 are carried to the paper discharge rollers 112 along the carrier path 107, and are discharged into the paper discharge tray 109.

The tag attaching unit 12 attaches the RFID tags to the respective tag-attachable sheets. In this embodiment, the tag attaching unit 12 applies adhesive agent on paper strips or films each attached with the RFID tag in advance and contact bonding the same onto the respective tag-attachable sheets on which the images are printed by the printing unit 11. However, the attaching method is not limited thereto, and a method of fixing with the paper strips or the films attached with the RFID tag in advance with a stapler may also be applicable. Although not shown in the drawing, a detection sensor for detecting whether the RFID tag remains or not is provided.

The RF writer 13 writes information onto a storage area of the RFID tag attached to the recording sheet via the wireless communication. When the RFID tag receives the electric wave oscillated by the RF writer 13, an electromotive power is generated in the RFID tag by the resonance action, and the RFID tag writes the information received by the generated electromotive power into the storage area thereof. The RF writer 13 writes writing information stored in the RAM 17 via the wireless communication in the storage area of the RFID tag attached by the tag attaching unit 12 to the tag-attachable sheet on which the image is recorded by the printing unit 11.

The operating unit 14 is provided with various operating keys interlocked with the display unit 15, such as a start key for issuing instruction to start image reading process of the original document, image printing process such as copying, and transmitting process, a ten-key for inputting the number of copies and the facsimile number of the destination, cursor keys or button keys for inputting various setups or destination address. Parts of the operating unit 14 and the control unit 1 function as accepting devices that accept start instruction for the transmitting process, the printing process and so on, the read setup and the writing information.

The display unit 15 includes an LCD (Liquid Crystal Display) configured to display various display screens and the operating state of the MFP 100 via characters or graphics. The LCD is of a touch panel type, and may be used instead of the operating unit 14 by the users to input various operations by touching the screen of the LCD with fingers.

The ROM 16 accommodates various programs that the control unit 1 uses for controlling the operations of the respective members of the MFP 100.

The RAM 17 functions as a main memory, a work area and the like of the control unit 1, and stores various data relating to the received image data and various data such as the setup information or the action information used for processing actions executed in the respective members of the MFP 100 in a readable and writable state. The setup information stored in the RAM 17 includes tag attachment setup information, destination writing setup information, tag reading setup information, and limited destination setup information. The tag attachment setup information is information indicating whether or not a tag attachment setup for setting the RFID tag on the recording sheet having the image printing thereon is to be set. The destination writing setup information is information indicating whether or not the destination writing setup for writing information indicating the destination on the RFID tag attached on the recording sheet having the image printed thereon as writing information is to be set. The tag reading setup information is information indicating whether or not information is read out from the RFID tag attached to the original document from which the image is read. The limited destination setup information is information indicating whether or not the image data acquired by reading the image from the original document is allowed to be transmitted to destinations other than the destination that the destination information indicates. The setup information stored in the RAM 17 can be changed by the user by inputting through the operating unit 14 or by inputting through the client PC 36. By retrieving the setup information stored in the RAM 17, the current setup conditions are determined.

The information that the RF reader 4 retrieve, and the writing information to be written by the RF writer 13 is stored in the RAM 17. The writing information stored in the RAM 17 is information relating to the recording sheets to which the RFID tag having the writing information written therein is to be attached, and includes transmit inhibit information, destination information, and limited destination information. The transmit inhibit information is information indicating that the transmitting of the image data acquired by reading the image printed on the recording sheet is inhibited. The destination information is information indicating the destination of the image data acquired by reading the image printed on the recording sheet, and more specifically, is a facsimile number or an electronic mail address. The limited destination information is information indicating whether the image data acquired by reading the image on the original document is allowed to be transmit to destinations other than the destination that the destination information indicates. The writing information includes usage specifying information indicating that the usage of the original document is specified (copy inhibit, confidential, and so on), information relating to the reading mode when reading the original document, the name of the original document, and creator of the original document (for example, the name of the company, the name of the division, and the name of the preparer). The writing information stored in the RAM 17 can be changed by the user by inputting through the operating unit 14 or by inputting through the client PC 36.

The modem 18 modulates and demodulates transmission data according to, for example, ITU-T (International Telecommunication Union Telecommunication Standardization Sector) recommended V.34 standard or equivalent. The NCU 19 is a line network control device which controls a telephone line to connect or disconnect a telephone, and is communicable connected to the facsimile apparatus 32 via the PSTN 31.

The LAN I/F 20 communicably connects the LAN 35 and the MFP 100. The LAN 35 is connected to a mail server 37 and a router 38, and to the internet facsimile apparatus 34 via the router 38 and the internet 33. The LAN 35 is also connected to the plurality of client PCs 36, so that the various functions of the MFP 100 can be used through the client PCs 36. The client PCs 36 each include a display unit for visualizing the image data on the screen and an operating unit to be operated for entering the information. Part of the control unit 1, the modem 18, the NCU 19, and the LAN I/F 20 function as transmitting devices.

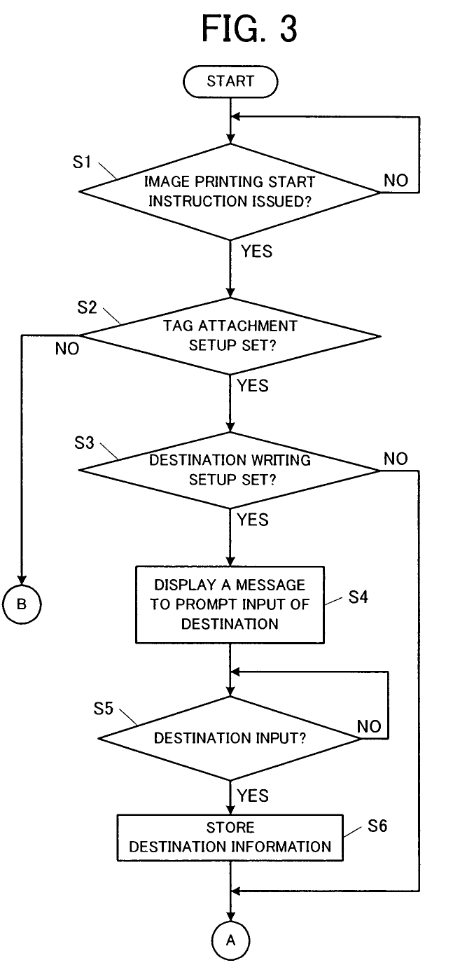

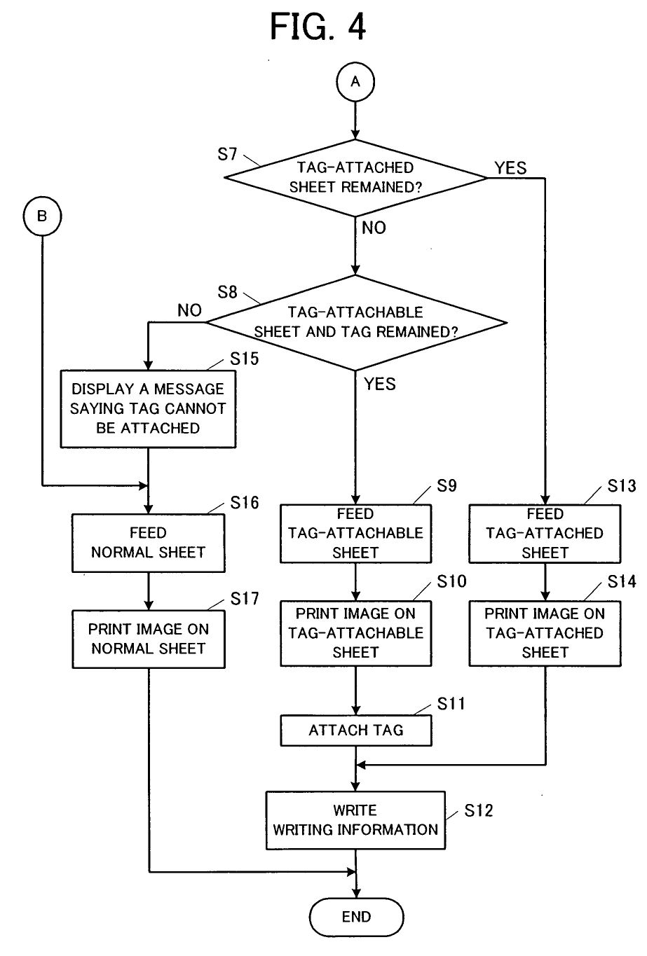

Referring now to the flowcharts in FIG. 3 and FIG. 4, the processing action executed in the MFP 100 when printing the image will be described. The processing actions executed in the MFP 100 described on the basis of the following flowchart are executed according to commands issued by the control unit 1 on the basis of the program stored in the ROM 16.

Whether an instruction is issued to start image printing or not is determined (S1). More specifically, it is determined that the instruction is issued to start the image printing when the detection sensor detects the fact that the original document is placed on the platen glass 101a or the document tray 103, “copy” is set through the operating unit 14 and the start key is pressed, when the image data is received from the facsimile apparatus 32 or the internet facsimile apparatus 34, and when a job in which the image should be printed is transferred from the client PC 36. When it is determined that there is no instruction issued to start the image printing (S1: NO), the MFP 100 assumes a waiting state. When it is determined that the instruction is issued to start the image printing (S1: YES), whether or not the tag attachment setup is set is determined (S2).

When it is determined that the tag attachment setup is set (S2: YES), whether or not the destination writing setup is set is determined (S3). When it is determined that the destination writing setup is set (S3: YES), a display to prompt input of a destination is displayed on the display unit 15 (S4). More specifically, a message to prompt the user to input the destination such as “Input the Destination” is displayed on the LCD of the display unit 15. When processing a job transferred from the client PC 36, a display to prompt the user to input the destination from the operating unit may be displayed on the display unit of the client PC 36. An alarm sound may be given through a speaker or the like, not shown. When the destination is input (S5: YES), inputted information is stored in the RAM 17 as the destination information (S6). When there is the destination information included in the job transferred from the client PC36 or in a header of an electronic mail received from the internet facsimile apparatus 34, the destination information may be extracted and stored in the RAM 17.

Subsequently (after S3: NO, or S6), whether or not there remains the tag-attached sheet is determined (S7). More specifically, whether or not the recording sheets are stored in the paper feed cassette 106c is detected by the detection sensor provided on the paper feed cassette 106c. Here, when it is determined that there is no tag-attached sheet remained (S7: NO), whether or not there remain the tag-attachable sheet and the RFID tag is determined (S8). More specifically, whether or not the recording sheets are stored in the paper feed cassette 106b is determined by the detection sensor provided on the paper feed cassette 106b, and whether or not there remains the RFID tag is determined by the detection sensor provided on the tag attaching unit 12 respectively. When it is determined that there remain the tag-attachable sheet and the RFID tag (S8: YES), the tag-attachable sheet feed unit 9 feeds the tag-attachable sheet to the printing unit 11 (S9). Then, the printing unit 11 prints the image on the basis of the image data retrieved from the image memory 7 onto the tag-attachable sheet (S10). More specifically, when copying the original document placed on the platen glass 101a and the document tray 103, the image of the original document is read by the reading unit 3, and the image data obtained thereby is processed by the image processing unit 5, and stored in the image memory 7. The image data received from the facsimile apparatus 32 and the internet facsimile apparatus 34 is stored in the image memory 7. The image data as the image file transferred from the client PC 36 is stored in the image memory 7. Then, when printing the image on the basis of the image data, the image data is decoded by the CODEC 6 and then the image is printed on the tag-attachable sheet. The tag attaching unit 12 attaches the RFID tag to the tag-attachable sheet having the image printed thereon (S11), the RF writer 13 writes the writing information on the RFID tag attached to the tag-attachable sheet (S12), discharges the same into the paper discharge tray 109, and terminates the operation. The RF writer 13 retrieves the writing information stored in the RAM 17 and writes the same into the RFID tag. When the destination information is included in the writing information, that is, when the destination information is stored in the RAM 17 in S6, the destination information is written in the RFID tag.

In contrast, when it is determined that there remains the tag-attached sheet (S7: YES), the tag-attached sheet feed unit 10 feeds the tag-attached sheet to the printing unit 11 (S13). Then, as in S10, the printing unit 11 prints the image on the basis of the image data retrieved from the image memory 7 onto the tag-attached sheet (S14). Then, the RF writer 13 writes the writing information on the RFID tag of the tag-attached sheet (S12), discharges the same into the paper discharge tray 109, and terminates the procedure.

On the other hand, when it is determined that there is no tag-attachable sheet and the RFID tag remained (S8: NO), the fact that the RFID tag cannot be attached to the recording sheet for printing the image is displayed on the display unit 15 (S15). More specifically, a message to prompt the user saying that the RFID tag cannot be attached to the recording sheet for printing the image such as “the tag cannot be attached to the recording sheet” is displayed on the LCD of the display unit 15. When processing a job transferred from the client PC 36, a display to prompt the user may be displayed via the display unit of the client PC 36. An alarm sound may be given through the speaker or the like, not shown. Subsequently, the normal sheet feed unit 8 feeds the normal sheet to the printing unit 11 (S16). Then, as in S10, the printing unit 11 prints the image on the basis of the image data retrieved from the image memory 7 onto the normal sheet (S17), discharges the same into the paper discharge tray 109, and terminates the procedure.

In contrast, when it is determined that the tag-attachment setup is not set (S2: NO), the normal sheet feed unit 8 feeds the normal sheets to the printing unit 11 (S16). Then, as in S10, the printing unit 11 prints the image on the basis of the image data retrieved from the image memory 7 onto the normal sheet (S17), discharges the same into the paper discharge tray 109, and terminates the procedure.

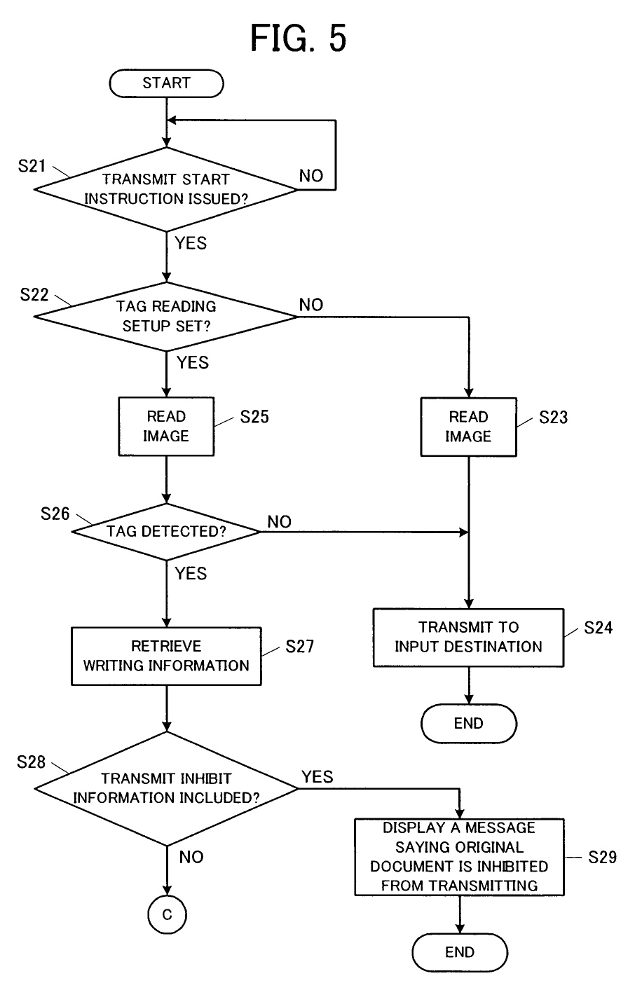

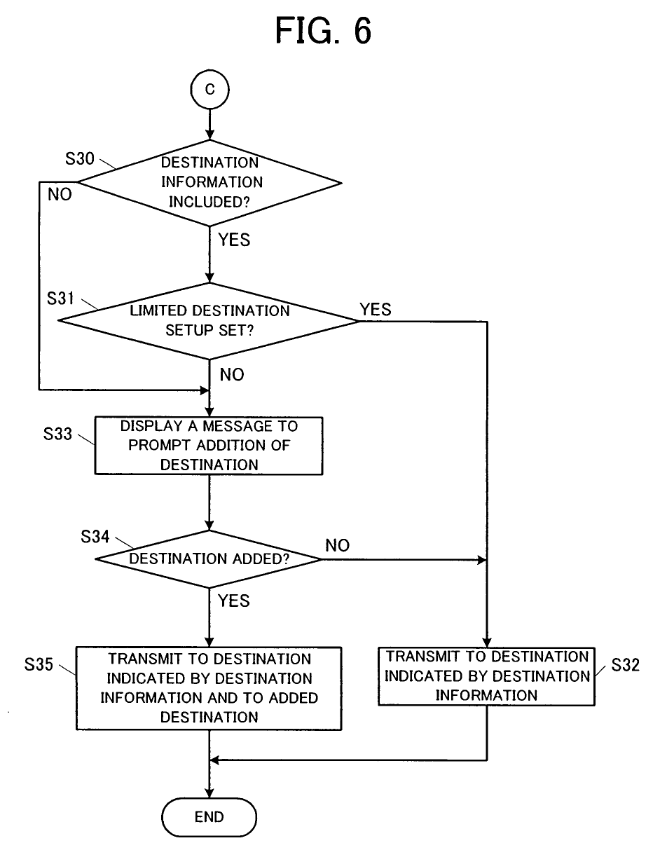

Referring now to the flowcharts shown in FIG. 5 and FIG. 6, a processing action executed in the MFP 100 when transmitting the image data acquired by reading the image of the original document will be described. The processing actions of the MFP 100 described on the basis of the following flowcharts are performed according to the commands issued by the control unit 1 on the basis of the programs stored in the ROM 16.

Firstly, whether or not the instruction is issued to start transmitting is determined (S21). More specifically, it is determined that the instruction is issued to start transmitting when the fact that the original document is placed on the platen glass 101a or the document tray 103 is detected by the detection sensor, the transmitting is set by the operation unit 14, and the start key is pressed. In this specification, when it is determined that there is no instruction issued to start transmitting (S21: NO), the MFP 100 assumes a waiting state. In contrast, when it is determined that the instruction is issued to start transmitting (S21: YES), whether or not the tag reading setup is set is determined (S22).

When it is determined that the tag reading setup is not set (S22: NO), the image of the original document is read (S23), and the acquired image data is transmitted to the destination which is input through the operating unit 14 (S24). More specifically, the image data is transmitted to the destination input already through the operating unit 14 before the fact that the instruction to start transmitting is issued in S21. Then, the procedure is terminated.

When it is determined that the tag reading setup is set (S22: YES), the reading unit 3 starts image reading of the original document (S25). At this time, the RF reader 4 detects whether or not the RFID tag is attached to the original document (S26). When the RFID tag is not detected (S26: NO), the read and acquired image data is transmitted to the destination input through the operating unit 14 (S24) and the procedure is terminated.

When the RFID tag is detected (S26: YES), the RF reader 4 retrieves the writing information stored in the storage area of the RFID tag (S27). Then, whether or not the transmit inhibit information is included in the retrieved writing information is determined (S28). When it is determined that the transmit inhibit information is included in the retrieved writing information (S28: YES), a message saying that transmitting of the image of the original document is inhibited is displayed on the display unit 15 (S29), and the procedure is terminated. More specifically, a message prompting the user that the original document cannot be transmitted, such as a message saying that transmitting of the original document is inhibited, is displayed on the LCD of the display unit 15. An alarm sound may be given through a speaker or the like, not shown.

On the other hand, when it is determined that the transmit inhibit information is not included in the retrieved writing information (S28: NO), whether or not the destination information is included in the retrieved writing information is determined (S30). When it is determined that the destination information is included in the writing information (S30: YES), whether or not the limited destination setup is set is determined (S31). More specifically, it is determined that the limited destination setup is set when the limited destination setup information retrieved from the RAM 17 or the limited destination information included in the writing information indicates that the limited destination setup should be set. When it is determined that the limited destination setup is set (S31: YES), the acquired image data is transmitted to the destination that the destination information indicates, which is included in the writing information (S32), and the procedure is terminated.

When it is determined that the limited destination setup is not set (S31: NO), confirmation is displayed on the display unit 15 asking the user whether or not addition of destination is desired (S33). More specifically, a message prompting the user to input additional destinations to the operating unit 14 if there is the additional destinations that the user wants to transmit the image data other than the destination XXXXXX that the destination information included in the writing information indicates, such as “Document will be sent to XXXXXX. Do you want to add destinations? If yes, input the destinations” is displayed on the LCD of the display unit 15. Also, an alarm sound may be given through a speaker or the like, not shown. When the destination is additionally input through the operating unit 14 (S34: YES), the acquired image data is transmitted to the destination that the destination information indicates, which is included in the writing information, and the destination input through the operating unit 14 (S35), and the procedure is terminated. When it is determined that the destination information is not included in the writing information (S30: NO), the acquired image data is transmitted only to the destination input through the operating unit 14. In contrast, when the destination is not input through the operating unit 14 (S34: NO), the acquired image data is transmitted to the destination that the destination information indicates, which is included in the writing information (S32), and the procedure is terminated. In S32 or S35, when the destination is already input through the operating unit 14, for example, in a case in which the destination is already input through the operating unit 14 before it is determined that the instruction is issued to start transmitting in S21, the image data is transmitted also to the corresponding destination.

As described above, when the RF reader 4 retrieves the destination information from the RFID tag attached to the original document, the MFP 100 is capable of transmitting the image data, which is acquired by reading the image of the original document, automatically to the destination that the destination information indicates. Therefore, the image data is reliably transmitted to the destination that the destination information indicates, and hence the image data is prevented from leaking due to the erroneous transmitting so that the security is enhanced. Since the user does not have to input the destination when transmitting the data, the transmitting process is simplified.

The MFP 100 transmits the image data only to the destinations indicated by the destination information retrieved by the RF reader 4 from the RFID tag attached to the original document when the limited destination setup is set even though the destination is input by the user through the operating unit 14. Therefore, the destination of the original document is reliably specified, and hence the image data is reliably transmitted only to the destination that the destination information indicates, so that the data is prevented from being transmitted to the wrong destination. Therefore, a reliable control of the transmitting of the original document is achieved.

When the limited destination setup is not set, the MFP 100 transmits the image data to the destination that the destination information retrieved by the RF reader 4 from the RFID tag attached to the original document indicates and to the destination that the user inputs through the operating unit 14. Therefore, the destination of the original document is not limited to the destination limited in advance, and hence the image data can be transmitted to the destination input through the operating unit 14. Therefore, a flexible control of the transmitting of the original document is achieved.

When the RF reader 4 retrieves the transmit inhibit information from the RFID tag attached to the original document, the MFP 100 does not execute the transmitting process. Therefore, the original document is reliably prevented from being transmitted and hence an inadequate transmitting is prevented. Therefore, a reliable control of the transmitting of the original document is achieved.

In the MFP 100, the RF writer 13 writes the destination information indicating the destination to the RFID tag which is attached to the recording sheets for printing the image via the wireless communication. Therefore, the recording sheet can be transmitted reliably to the destination that the destination information indicates by transmitting the recording sheets as the original document using the MFP 100, so that the image data is prevented from leaking due to the erroneous transmitting and enhancement of the security is achieved. Since the user does not have to input the destination when transmitting the recording sheet, the transmitting process is simplified.

In the MFP 100, the writing information which is to be written into the RFID tag attached to the recording sheet for printing the image can be input through the operating unit 14. Therefore, the writing information such as information on the usage including the transmitting of the recording sheet can be input by the user through the operating unit 14 as needed, and hence an adequate usage of the recording sheet is reliably achieved.

With the MFP 100, when printing the image on the recording sheet and discharging once, and then transmitting the recording sheet after putting a signature thereon by hand, by writing the destination information of the destination in the RFID tag of the recording sheet in advance, erroneous transmitting is reliably prevented. In this case, the user can transmit the image data only by setting the transmit setup and pressing the start button through the operating unit 14, and it is not necessary to input the destination through the operating unit 14.

In a case of preparing the original document by the client PC36, for example, when the facsimile number of the destination is written on the original document, the destination can be set only by copying the facsimile number and inputting as the destination information, so that the destination of the original document can easily and reliably be specified.

The configuration of the MFP 100 shown in the preferred embodiment is simply an example of the communication terminal apparatus and the image printing apparatus according to the invention, and various modifications may be made without departing the scope of the invention. For example, although the example in which three sheet feed units; the normal sheet feed unit 8, the tag-attachable sheet feed unit 9 and the tag-attached sheet feed unit 10 are provided is shown, a configuration including at least any one of the tag-attachable sheet feed unit 9 and the tag-attached sheet feed unit 10 is also applicable.

Although the example in which the writing information is written in the RFID tag attached to the recording sheet having the image already printed thereon is shown, a configuration adapted to write the writing information in the RFID tag attached to the recording sheet before the image is printed is also applicable. Although the example in which the writing information is written in the RFID tag having attached to the recording sheet is shown, a configuration adapted to write the writing information on the RFID tag before being attached to the recording sheet is also applicable. Although the example in which the RFID tag is attached to the recording sheet having the image printed thereon is shown, a configuration adapted to attach the RFID tag to the recording sheet before the image is printed is also applicable.

Although the mode in which the communication terminal apparatus and the image printing apparatus are implemented as the MFP 100 is shown in this embodiment, the communication terminal apparatus and the image printing apparatus are not limited to the MFP 100, and may be applied to a copying machine, a facsimile machine, a scanner, and a multi-functional machine including these machines combined therein. It may also be an apparatus which functions only as the communication terminal apparatus, or as the image printing apparatus.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true sprit and scope of the present invention.

What is claimed is:

1. A communication terminal apparatus comprising:
an image data acquiring device configured to read an image of an original document and to acquire an image data;
a retrieving device configured to retrieve information from a storage medium attached to the original document via a wireless communication; and
a transmitting device configured to transmit the image data acquired by the image data acquiring device to a destination indicated by destination information when the retrieving device retrieves the destination information.

2. The communication terminal apparatus according to claim 1, further comprising:
an operation inputting device configured to operate to input destinations,
wherein the transmitting device transmits the data only to the destination that the destination information indicates from between the destination that the destination information retrieved by the retrieving device indicates, and the destination input through the operation inputting device.

3. The communication terminal apparatus according to claim 1, further comprising:
an operation inputting device configured to operate to input destinations,
wherein the transmitting device transmits the data to the destination that the destination information retrieved by the retrieving device indicates, and the destination input through the operation inputting device.

4. The communication terminal apparatus according to claim 1, wherein the transmitting device inhibits the transmitting process when the retrieving device retrieves transmit inhibit information.

5. The communication terminal apparatus according to claim 4, further comprising:
a notifying device configured to notify a user with a message saying that an original document cannot be transmitted when the transmitting device inhibits the transmitting process.

6. The communication terminal apparatus according to claim 1, wherein the destination information may be a facsimile number or an electronic mail address.

7. The communication terminal apparatus according to claim 1, wherein the transmitting device inhibits the transmitting process for other than the destination that the destination information indicates when the retrieving device has retrieved the fact that limited destination setup that limits the destination is set.

8. The communication terminal apparatus according to claim 7, further comprising:
a notifying device configured to notify a user with a message for confirming whether or not the addition of the destination is desired when the limited destination setup is not set.

9. The communication terminal apparatus according to claim 1, further comprising:
a setup information storage device configured to store a tag reading setup,
wherein the transmitting device transmits the image data to a destination indicated by the destination information retrieved by the retrieving device when the tag reading setup is set, and transmits the image data to a destination input through the operation inputting device when the tag reading setup is not set.

10. An image printing apparatus comprising:
a printing device that prints an image onto a recording sheet;
an accepting device that accepts destination information indicting a destination as writing information; and
a writing device that writes the writing information accepted by the accepting device into a storage medium attached to the recording sheet via a wireless communication.

11. The image printing apparatus according to claim 10, further comprising:
an operation inputting device configured to operate to input the writing information,
wherein the accepting device accepts writing information input through the operation inputting device.

12. The image printing apparatus according to claim 10, wherein the destination information may be a facsimile number or an electronic mail address.

13. The image printing apparatus according to claim 10, further comprising:
a setup information storage device that stores a destination writing setup for writing the destination information into the storage medium,
wherein the accepting device controls to display a massage prompting input of the destination when the destination writing setup is set.

14. The image printing apparatus according to claim 10, wherein the setup information storage device further stores a tag attachment setup, and
wherein the printing device selects a recording sheet having the storage medium attached thereto as a target recording sheet when the tag attachment setup is set, and selects the recording sheet on which the storage medium is not attached thereto as the target recording sheet when the tag attachment setup is not set.

15. The image printing apparatus according to claim 10, further comprising:
an attaching device that attaches the storage medium to the recording sheet,
wherein the setup information storage device further stores the tag attachment setup, and
wherein the attaching device attaches the storage medium on the recording sheet as a recording target for the printing device when the tag attachment setup is set, and does not attach the storage medium to the recording sheet as the recording target for the printing device when the tag attachment setup is not set.

16. The image recording apparatus according to claim 10, further comprising:
an attaching device that attaches the storage medium to the recording sheet,
wherein in the case in which the tag attachment setup is set, and when there is no recording sheet having the storage medium attached thereto, the attaching device attaches the storage medium to the recording sheet as a recording target of the printing device.

17. A method of communication comprising:
an image data acquiring step for reading an image of an original document and acquiring image data;
a retrieving step for retrieving information from a storage medium attached to the original document via a wireless communication; and
a transmitting step for transmitting image data acquired at the image data acquiring step to a destination that destination information indicates when the destination information is retrieved at the reading step.

18. A method of printing an image comprising:
a printing step for printing an image on a recording sheet;
an accepting step for accepting destination information indicating a destination as writing information; and
a writing step for writing the writing information accepted at the accepting step to a storage medium attached to the recording sheet via a wireless communication.
